(19) United States
(12) Patent Application Publication
(10) Pub. No.: US 2016/0260121 A1
(43) Pub. Date: Sep. 8, 2016

(54) METHODS AND APPARATUS TO ALLOCATE ADVERTISEMENTS IN AN ADVERTISING CAMPAIGN

(71) Applicant: The Nielsen Company (US), LLC, New York, NY (US)

(72) Inventor: Leslie Wood, Copake Falls, NY (US)

(21) Appl. No.: 14/926,445

(22) Filed: Oct. 29, 2015

Related U.S. Application Data
(60) Provisional application No. 62/128,370, filed on Mar. 4, 2015.

(51) Int. Cl. G06Q 30/02

(52) U.S. Cl. CPC G06Q 30/0243

(57) ABSTRACT

Methods and apparatus to allocate advertising elements to selected campaign variables are disclosed. An example method includes selecting one of a first campaign variable and a second campaign variable based on a first penalty associated with the first campaign variable and a second penalty associated with the second campaign variable, the first penalty representative of non-allocation of a first advertising element to the first campaign variable, the second penalty representative of non-allocation of a second advertising element to the second campaign variable; selecting a target advertising element based on efficacy scores associated with the first and second campaign variables; and allocating the target advertising element to the selected one of the first and second campaign variables.

### RELATED APPLICATIONS

The present application is a continuation of U.S. Provisional Pat. App. No. 62/128,370 titled “Method and Apparatus to Allocate Advertisements in an Advertising Campaign” to Wood, filed Mar. 4, 2015, the contents of which are incorporated by reference in their entirety herein.

### FIELD OF THE DISCLOSURE

This disclosure relates generally to advertising and, more particularly, to methods and apparatus to allocate advertisements in an advertising campaign.

### BACKGROUND

Entities that design and/or implement advertising campaigns have a responsibility to select the time slot and/or location for an advertisement that achieves the best return. For example, it is desirable to place advertisements in locations and times where they will be seen by consumers who are likely to favorably respond to the advertisement (e.g., by purchasing the advertised product or service). Thus, selecting these times and locations is an effort to efficiently use resources (e.g., the money spent to deliver the advertisement). Efforts to achieve such efficiency include allocation of resources (e.g., advertisements, advertising money, etc.) to different targets (e.g., time slots, networks, program categories, platforms, etc.) according to, for example, an efficacy (e.g., an effect at generating a desired result) of the respective resources when allocated to the different targets. For example, a first resource may be more effective for its purpose when allocated to a first target than when allocated to a second target. Additionally or alternatively, a second resource may be more effective for its purpose when allocated to the first target than the first resource for its purpose when allocated to the first target.

### BRIEF DESCRIPTION OF THE DRAWINGS

FIG. 1 is a block diagram of an example allocation system constructed in accordance with teachings of this disclosure.

FIG. 2 is an example implementation of the example sorting table, and the non-allocation penalty table, of FIG. 1.

FIG. 3 is an example implementation of the example goal table of FIG. 1.

FIG. 4 is an example implementation of the average goal table of FIG. 1.

FIG. 5 is an example implementation of the allocated campaign variable table 132 of FIG. 1.

FIGS. 6A-6D are flowcharts representative of example machine readable instructions that may be executed to implement the example allocation system of FIG. 1.

FIG. 7 illustrates a first example state of the example sorting table of FIGS. 1 and/or 2.

FIG. 8 illustrates a first example state of the example goal table of FIGS. 1 and/or 3.

FIG. 9 illustrates a first example state of the average goal table of FIGS. 1 and/or 4.

FIG. 10 illustrates a second example state of the example sorting table, and the non-allocation penalty table, of FIGS. 1 and/or 2.

FIG. 11 illustrates a third example state of the example sorting table, and the non-allocation penalty table, of FIGS. 1 and/or 2.

FIG. 12 illustrates a first example state of the example allocated campaign variable table of FIGS. 1 and/or 5.

FIG. 13 illustrates a fourth example state of the example sorting table, and the non-allocation penalty table, of FIGS. 1 and/or 2.

FIG. 14 illustrates a second example state of the example allocated campaign variable table of FIGS. 1 and/or 5.

FIG. 15 illustrates a third example state of the example allocated campaign variable table of FIGS. 1 and/or 5.

FIG. 16 illustrates a fourth example state of the example allocated campaign variable table of FIGS. 1 and/or 5.

FIG. 17 illustrates a fifth example state of the example sorting table, and the non-allocation penalty table, of FIGS. 1 and/or 2.

FIG. 18 illustrates a fifth example state of the example allocated campaign variable table of FIGS. 1 and/or 5.

FIG. 19 illustrates a sixth example state of the example sorting table, and the non-allocation penalty table, of FIGS. 1 and/or 2.

FIG. 20 illustrates a sixth example state of the example allocated campaign variable table of FIGS. 1 and/or 5.

FIG. 21 illustrates a seventh example state of the example sorting table of FIGS. 1 and/or 2.

FIG. 22 illustrates a seventh example state of the example allocated campaign variable table of FIGS. 1 and/or 5.

FIG. 23 illustrates an eighth example state of the example sorting table of FIGS. 1 and/or 2.

FIG. 24 illustrates an eighth example state of the example allocated campaign variable table of FIGS. 1 and/or 5.

FIG. 25 illustrates a ninth example state of the example allocated campaign variable table of FIGS. 1 and/or 5.

FIG. 26 illustrates an example state of the example results table of FIG. 1.

FIG. 27 is a block diagram of an example computing platform structured to implement the example allocation system of FIG. 1 by executing the example machine readable instructions of FIGS. 6A-6D.

### DETAILED DESCRIPTION

Example methods and apparatus disclosed herein allocate advertising elements having different efficacies/effectiveness for different purposes (e.g., driving sale, promoting brand recognition, etc.) to target groups or advertising campaign variables, based on criteria and/or goals of a program (e.g., an advertising campaign). An “advertising campaign variable,” also known as a “campaign variable,” is any part of the advertising campaign that can be adjusted. For example, time slots for the ads, ad types, geographic locations for the ads, channels, distribution platforms (e.g., Television, radio, billboards, online ads, etc.), frequency of the ad, etc. An advertising element is a brand, a product, a product category, a service, a service category, a marketplace, an industry, etc. of an entity implementing an advertising campaign. Examples disclosed herein recognize that a particular advertising element has a first efficacy when paired with a first one of the target campaign variables and a second, lesser efficacy when paired with a second one of the target campaign variables. Examples disclosed herein recognize that, in such instances, allocating the particular advertising element to the second campaign variable rather than the first campaign variable incurs a penalty because the advertising element was not allocated to the campaign variable that will enable the advertising element to be more effective. Examples disclosed herein refer to this penalty as a “non-allocation penalty.” Examples disclosed herein allocate a set advertising elements across a set of campaign variables such that the corresponding “non-allocation penalties” are reduced (e.g., minimized). As disclosed in detail below, examples disclosed herein allocate the advertising elements based on the non-allocation penalties and one or more goals, criteria and/or rules.

Disclosed example methods and apparatus are described below in a context of a marketing campaign, an advertising campaign, campaign variables, advertisements, advertisement slots, media ratings, gross rating points (GRPs) and expenditures. However, example methods and apparatus disclosed herein to allocate advertising element can be utilized in any suitable type of context and/or system in which advertising element are desirably allocated in an efficient, productive manner.

The apparatus disclosed herein is also applied to an allocation of household to target or audience segments where they propensity is known for each household to be within each segment, and the size of each segment is known.

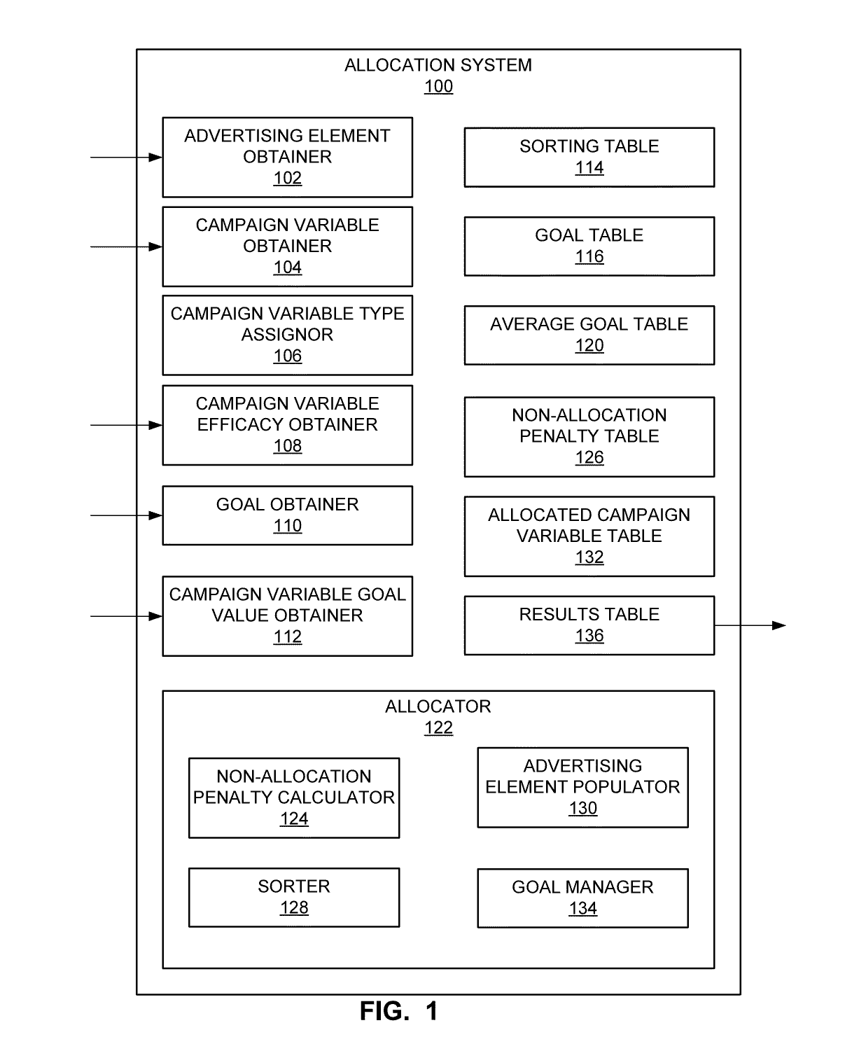

FIG. 1 illustrates an example allocation system 100 constructed in accordance with teachings of this disclosure. In the illustrated example of FIG. 1, the allocation system 100 is tasked with allocating advertising elements to campaign variables, where an advertising element represents an advertisement for a brand, a product, a product category, a service, a service category, a marketplace, an industry, etc., and a campaign variable represents any part of the advertising campaign that can be adjusted (e.g., time slots for the ads, ad types, geographic locations for the ads, channels, distribution platforms (e.g., television, radio, billboards, Internet or online ads, etc.), frequency of the ad, etc.), which may be part of a broader marketing campaign. Thus, the example allocation system 100 of FIG. 1 is tasked with selecting, for each ad of the advertising campaign, one or more of a plurality of available advertisement slots.

For example, the allocation system 100 of FIG. 1 allocates a first advertisement during a scheduled television program (e.g., the campaign variable of program type, for example a sitcom) and a second advertisement during a news broadcast. The first and second advertisements are associated with Cheerios® (e.g., a brand). While this example includes a specific brand or product (i.e., Cheerios®), the advertising element may be any level of granularity (e.g., SKU (stock-keeping unit), product category, industry, marketplace, etc.). As disclosed in detail below, the example allocation system of FIG. 1 is tasked with performing the allocation of the advertising element (e.g. the ads) to the campaign variable in accordance with goals (e.g., exposure likelihoods), restrictions (e.g., budgetary constraints), and/or rules (e.g., percentage(s) of funds dedicated to particular campaign aspects) of the advertising campaign.

The example allocation system of FIG. 1 includes an advertising element obtainer 102 to obtain advertising element to be allocated by the allocation system of FIG. 1. The example advertising element obtainer 102 of FIG. 1 obtains the advertising element from, for example, the entity implementing the advertising campaign. In the illustrated example of FIG. 1, one of the obtained advertising element represents a brand, a product, a product category, a service, a service category, a marketplace, an industry, etc. In the illustrated example of FIG. 1, the advertising elements obtained by the advertising element obtainer 102 correspond to brands.

The example allocation system of FIG. 1 includes a campaign variable obtainer 104 to obtain campaign variables into which the advertising element of the advertising campaign are to be assigned. The example campaign variable obtainer 104 of FIG. obtains the campaign variables from, for example, one or more sources of available advertisement slots such as, for example, a television network or cable company that sells advertising space during television programming. In the illustrated example of FIG. 1, the campaign variables are advertisement slots that are available for purchase by, for example, the entity implementing the advertising campaign.

The example allocation system of FIG. 1 includes a campaign variable type assignor 106 to categorize the campaign variables obtained by the campaign variable obtainer 104 according to any suitable manner of categorization. The example campaign variable type assignor 106 implements the categorization of the campaign variables in accordance with, for example, instructions from the entity implementing the advertising campaign. That is, the example campaign variable type assignor of FIG. 1 enables, for example, the entity implementing advertising campaign to designate how the campaign variables are to be categorized (e.g., broken into groups) in any suitable manner. In the illustrated example of FIG. 1, the campaign variable type assignor 106 categorizes the campaign variables according to a period of time at which the corresponding advertisement slot occurs, a week during which the corresponding advertisement slot occurs, and a duration of the corresponding advertisement slot.

For example, a first campaign variable type assigned by the example campaign variable type assignor 106 is advertisement slots occurring during the daytime, during the week of Mar. 2, 2015, and having a thirty (30) second duration. In the illustrated example of FIG. 1, the campaign variable type assignor 106 assigns such campaign variables a ‘RED’ type identifier. Additionally, a second campaign variable type assigned by the example campaign variable type assignor 106 is advertisement slots occurring during primetime, during the week of Mar. 2, 2015, and having a fifteen (15) second duration. In the illustrated example of FIG. 1, the campaign variable type assignor assigned such campaign variables a ‘BLUE’ type identifier. The campaign variable types must be all inclusive and mutually exclusive across all elements in 104.

The example allocation system 100 of FIG. 1 includes a campaign variable efficacy obtainer 108 to obtain an efficacy score for each campaign variable obtained by the campaign variable obtainer 104 when each of the advertising element obtained by the advertising element obtainer 102 is assigned to the campaign variable. In the illustrated example of FIG. 1, the campaign variable efficacy obtainer 108 obtains the efficacy scores from, for example, a media measurement entity (e.g., The Nielsen Company), a television programming entity, and/or any other suitable source. In the illustrated example of FIG. 1, each of the advertising elements has one efficacy score when assigned to each of the campaign variables. Accordingly, a particular advertising element (e.g., brand) has a first efficacy score corresponding to a first one of the campaign variables (e.g., advertisement slot), a second efficacy score corresponding to a second one of the campaign variables, etc. An individual one of the efficacy scores indicates a likelihood that persons interesting in the corresponding advertising element (e.g., brand) will watch media presented during the corresponding campaign variable (e.g., advertisement slot). The example allocation system of FIG. 1 includes a goal obtainer 110 to obtain goals of the advertising campaign. The example goal obtainer 110 of FIG. 1 obtains the goal information from, for example, the entity implementing the advertising campaign. In the illustrated example of FIG. 1, the goal information includes one or more goals for each advertising element by campaign variable type. For example, for a first advertising element that represents a brand, a first goal for that brand in the first campaign variable type (e.g., campaign variables categorized with the ‘RED’ type identifier) is a first gross rating point (GRP) indicative of a number of impressions. Additionally or alternatively, for the first advertising element that represents the brand, a second goal for that brand in the first campaign variable type (e.g., campaign variables categorized with the ‘RED’ type identifier) is a first total cost in terms of, for example, dollars. Additionally or alternatively, for the first advertising element that represents the brand, a third goal for that brand in the second campaign variable type (e.g., campaign variables categorized with the ‘BLUE’ type identifier) is a second GRP. Additionally or alternatively, for the first advertising element that represents the brand, a fourth goal for that brand in the second campaign variable type (e.g., campaign variables categorized with the ‘BLUE’ type identifier) is a second total cost. In some examples, the first and second GRPs are different values. In some examples, the first and second GRPs are a same value. In some examples, the first and second total costs are different value. In some examples, the first and second total costs are a same value. Each 104 element will have a 108 score for every 102 brand.

The example allocation system 100 of FIG. 1 includes a campaign variable goal value obtainer 112 to obtain goal values for the campaign variables obtained. In the illustrated example of FIG. 1, the campaign variable goal value obtainer 112 accesses the goal values from, for example, a media measurement entity (e.g., The Nielsen Company), a television programming network, etc. In the illustrated example of FIG. 1, a goal value for one of the campaign variables is, for example, a rating of the campaign variable (e.g., an advertisement slot) or a cost of the campaign variable. For example, when one of the goal(s) obtained by the goal obtainer 110 is a GRP, the campaign variable goal value obtainer 112 obtains a rating for the advertisement slots represented by the campaign variables. Additionally or alternatively, when the one of the goal(s) obtained by the goal obtainer 110 is a total cost, the campaign variable goal value obtainer 112 obtains a cost for the advertisement slots represented by the campaign variables.

The example allocation system 100 of FIG. 1 includes a plurality of data structures to track or maintain data obtained by the advertising element obtainer 102, the campaign variable obtainer 104, the campaign variable efficacy obtainer 108, the goal obtainer 110, and the campaign variable goal value obtainer 112. In the example of FIG. 1, the data structures are tables. However, any suitable type of data structure is possible.

The example allocation system 100 of FIG. 1 includes a sorting table 114, a goal table 116, an average goal table 120, a non-allocation penalty table [126], an allocated campaign variable table 132 and a results table 136. The sorting table 114, the goal table 116, the average goal table 120, the non-allocation penalty table and the allocated campaign variable table 132 are populated with information for use in the allocation process. The results table 136 is used to summarize the results of the allocation process.

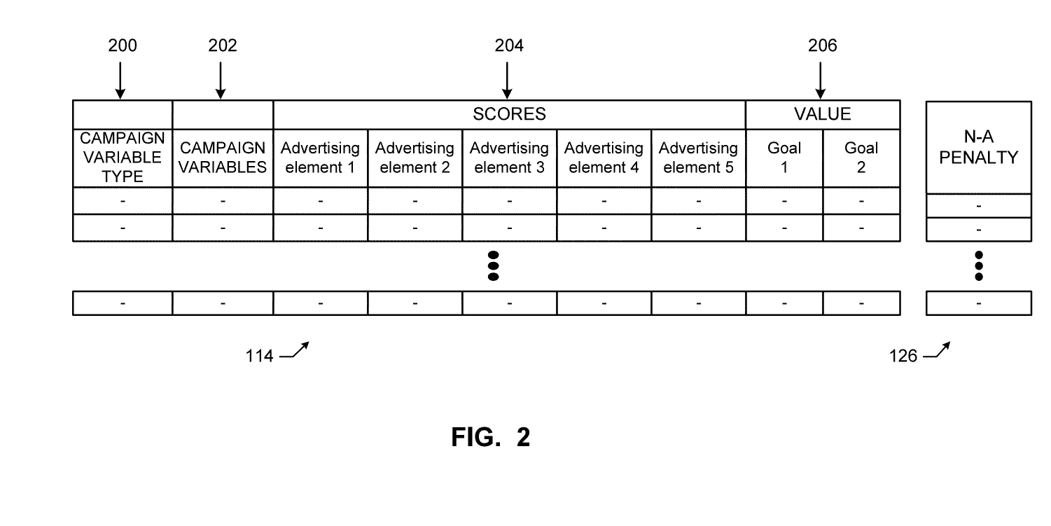

An example implementation of the sorting table 114 of FIG. 1 is illustrated in FIG. 2. In the example of FIG. 2, a first portion 200 of the sorting table 114 is populated by the example campaign variable type assignor 106 to indicate a type of each campaign variable (e.g., advertisement slot) obtained by the campaign variable obtainer 104. In the example of FIG. 2, a second portion 202 of the sorting table 114 is populated by the campaign variable obtainer 104. In the example of FIG. 2, a third portion 204 is populated by the advertising element obtainer 102 and the campaign variable efficacy obtainer 108. In particular, the third portion 204 includes each of the obtained advertising elements (e.g., brands) of the advertising campaign and a plurality of efficacy scores (e.g., likelihoods of a person interested in a subject of the advertising element consuming the item) for each advertising element, the different efficacy scores corresponding to the different campaign variables listed in the second portion 202. In the example of FIG. 2, a fourth portion 206 of the sorting table 114 is populated by the campaign variable goal value obtainer 112. While the example sorting table 114 of FIG. 2 includes five (5) advertising element and two (2) goals, any suitable number of advertising element and any suitable number of goals are possible. As disclosed in detail below, the example sorting table 114 is sorted based on, for example, the campaign variable type identifiers of the first portion 200 and non-allocation penalties of the different campaign variables, which is disclosed in detail below. Further, as disclosed in detail below, the example sorting table 114 is utilized to select ones of the advertising elements for allocation to ones of the campaign variables based on the sorting of the sorting table 114.

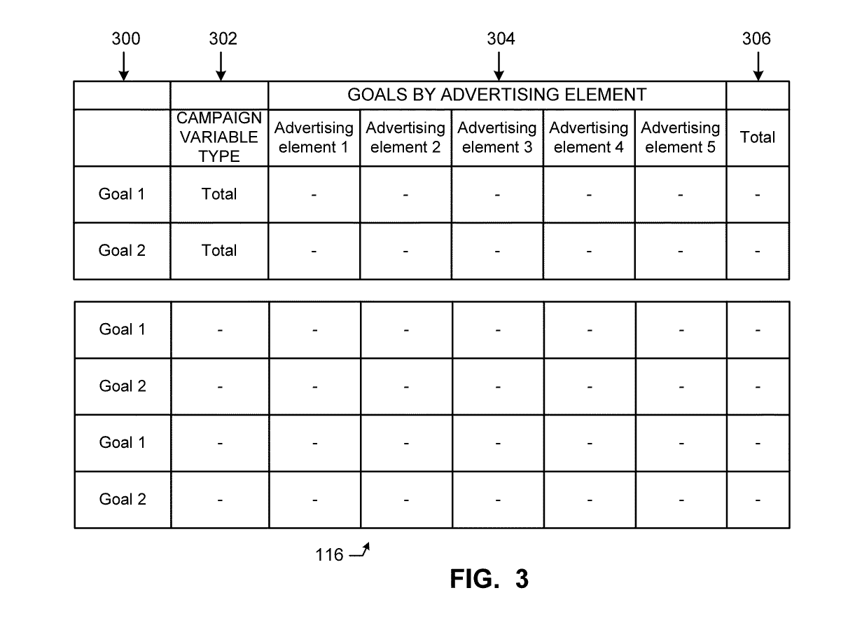

The example allocation system 100 of FIG. 1 includes a goal table 116 to be populated with information obtained by the example goal obtainer 110. An example implementation of the goal table 116 is illustrated in FIG. 3. In the example of FIG. 3, the goal table 116 includes a first portion 300 that lists the different goals of the advertising campaign. In the example of FIG. 3, the goal table 116 includes a second portion 302 that lists the different campaign variable types for which goal information is obtained. In the example of FIG. 3, the goal table 116 includes a third portion 304 that includes each of the obtained advertising elements (e.g., brands) of the advertising campaign and a plurality of goals (e.g., desired GRPs) for each advertising element, the different goals corresponding to the different campaign variable types listed in the second portion 302. The example goal table 116 of FIG. 3 includes entries for the total goal for each goal (shown as the top segment in FIG. 3), as well as the individual goals broken down according to the separate campaign variable types (shown as the bottom segment in FIG. 3). In the example of FIG. 3, the goal table 116 includes a fourth portion 306 that lists the total of the goals in each row. As disclosed in detail below, the example goal table 116 represents goals for the different advertising elements and/or the different campaign variable types and the allocation process allocates the advertising elements to the campaign variables such that the goals are achieved.

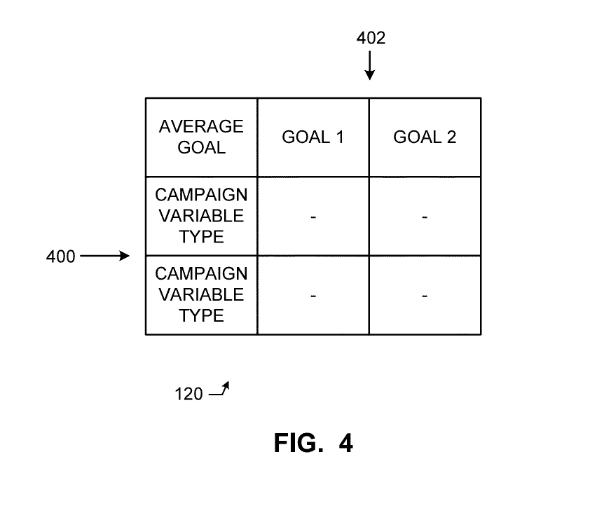

The example allocation system 100 of FIG. 1 includes an average goal table 120 populated with averages of the goals listed in the example goal table 116. An example implementation of the average goal table 120 is illustrated in FIG. 4. In FIG. 4 the vertical axis 400 lists the campaign variable types and the horizontal axis 402 list the different goals.

The example allocation system 100 of FIG. 1 includes an allocator 122 to interact with and utilize the information of, for example, the sorting table 114 and the goal table 116. In particular, the example allocator 122 of FIG. 1 analyzes and manipulates the data of the sorting table 114 in accordance with the goal table 116 in a manner such that the advertising elements are allocated to the campaign variables in an efficient manner. The example allocator 122 of FIG. 1 includes a non-allocation penalty calculator 124 to determine a penalty associated with not allocating an advertising element to a particular campaign variable. To determine the penalty for one of the advertising elements, the example non-allocation penalty calculator 124 of FIG. 1 calculates a difference between (1) a highest one of the efficacy scores in the corresponding row of the third section 204 of the sorting table 114 and (2) a second highest one of the efficacy scores in the corresponding row of the third section 204 of the sorting table 114. Thus, the determined non-allocation penalty for that advertising element represents a loss of efficacy should the advertising element not be allocated to the campaign variable for which the campaign variable is most effective. In the example of FIG. 1, the non-allocation penalty calculator 124 calculates the non-allocation penalty for each advertising element when assigned to a campaign variable (e.g., a row in the sorting table 114) and populates a non-allocation penalty table 126 with the non-allocation penalties. The example non-allocation penalty table 126 includes an entry for each campaign variable of the sorting table 114. An example implementation of the example non-allocation penalty table 126 is illustrated in FIG. 2 adjacent to the example sorting table 114.

The example allocator 122 of FIG. 1 includes a sorter 128 to sort the example sorting table 114 in accordance with, for example, the campaign variable type and the non-allocation penalties. In the illustrated example of FIG. 1, the sorter 128 first sorts the campaign variables (e.g., the rows) of the sorting table 114 according to campaign variable type. Put another way, the example sorter 128 divides the sorting table 114 into a first section including campaign variables of a first type, a second section including campaign variables of a second type, etc. In some examples, the sorter 128 sorts the campaign variable types according to restrictiveness of the campaign variable types. For example, the sorter 128 may place more restrictive campaign variable types above less restrictive campaign variable types. In such examples, the restrictiveness of a campaign variable type is measured by, for example, a number of that type of campaign variables in the sorting table 114. That is, in some examples, campaign variables of which there are a least amount are sorted to the top of the sorting table 114 such that those campaign variables are processed before more numerous campaign variable types.

In the illustrated example of FIG. 1, after sorting the campaign variables of the sorting table 114 according to campaign variable type, the sorter 128 sorts the campaign variables of the sorting table 114 according to the non-allocation penalties. In particular, the example sorter 128 of FIG. 1 places the campaign variable (e.g., row) having the greatest non-allocation penalty at a top of the sorting table (e.g., as the topmost row). The example sorter 128 of FIG. 1 places the campaign variable having the second greatest non-allocation penalty at a second position of the sorting table, below the top row. Thus placing the campaign variable that has the most value to a single 102 or estimator option.

The example allocator 122 of FIG. 1 includes an advertising element populator 130 to allocate particular ones of the advertising element to particular ones of the campaign variables. In the illustrated example of FIG. 1, the advertising element populator 130 identifies which of the advertising element not yet allocated to a campaign variable has a highest non-allocation penalty. In the example of FIG. 1, identifying such an advertising element includes determining which of the campaign variables is at the top row of the sorting table 114. The example advertising element populator 130 allocates an advertising element to the identified campaign variable (e.g., the top row of the sorting table 114) for which the advertising element has a greatest efficacy score. In the example of FIG. 1, identifying the greatest efficacy score for the advertising element assigned to the identified campaign variable includes analyzing the third portion of the sorting table 204. Having identified the advertising element having the highest non-allocation penalty and the greatest efficacy score for that identified campaign variable, the example advertising element populator 130 allocates that advertising element to the campaign variable corresponding to the greatest efficacy score. Thus, the example advertising element populator 130 of FIG. 1 assigns a brand (e.g., an advertising element) to an advertisement slot (e.g., a campaign element).

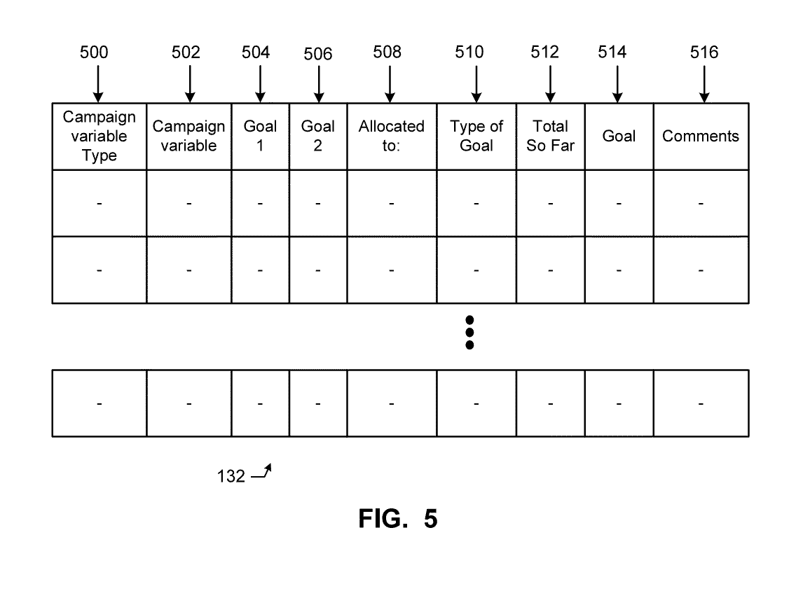

The example allocation system 100 includes an allocated campaign variable table 132 to track which advertising elements have been allocated to which campaign variables and to track the contribution of the advertising elements variables to the corresponding goal of the advertising campaign. An example implementation of the allocated campaign variable table 132 of FIG. 1 is illustrated in FIG. 5. The example allocated campaign variable table 132 of FIG. 5 includes a first section 500 indicating a type of the allocated campaign variable, a second section 502 identifying the allocated campaign variable, a third section 504 indicating a value of a first goal of the allocated campaign variable, a fourth section 506 indicating a value of a second goal of the allocated campaign variable, a fifth section 508 indicating which advertising element was assigned to this campaign variable, a sixth section 510 indicating which of the goals was the basis of the allocation, a seventh section 512 indicating how much of the corresponding goal has been achieved for the corresponding advertising element and type of campaign variable, an eighth section 514 indicating the goal, and a ninth section 516 indicating comments (e.g., whether the corresponding advertising element goal has been achieved based on that allocation). When the example advertising element populator 130 allocates one of the advertising element to a campaign variables, the example advertising element populator 130 populates the allocated campaign variable table 132 with the appropriate information.

The example allocator 122 includes a goal manager 134 to update the goals as advertising element are allocated to campaign variables. Additionally, in some examples, the goal manager 134 of FIG. 1 manipulates the goals (e.g., by calculating a threshold within which the goals are to be achieved) such that allocation of advertising element to campaign variables do not over-achieve the goals. For example, the goal manager 134 may establish a threshold or range (e.g., ninety (90) percent) of a goal that needs to be obtained for that goal to be considered met. In some examples, when the goal manager 134 determines that the threshold or range, such as ninety (90) percent, but not the entire (e.g., one-hundred (100) percent) goal has been met, the example goal manager 134 places that goal on hold, thereby restricting allocation to that goal, until all goals have at least been achieved within the threshold, after which the hold is released and any remaining advertising elements can be allocated without restriction.

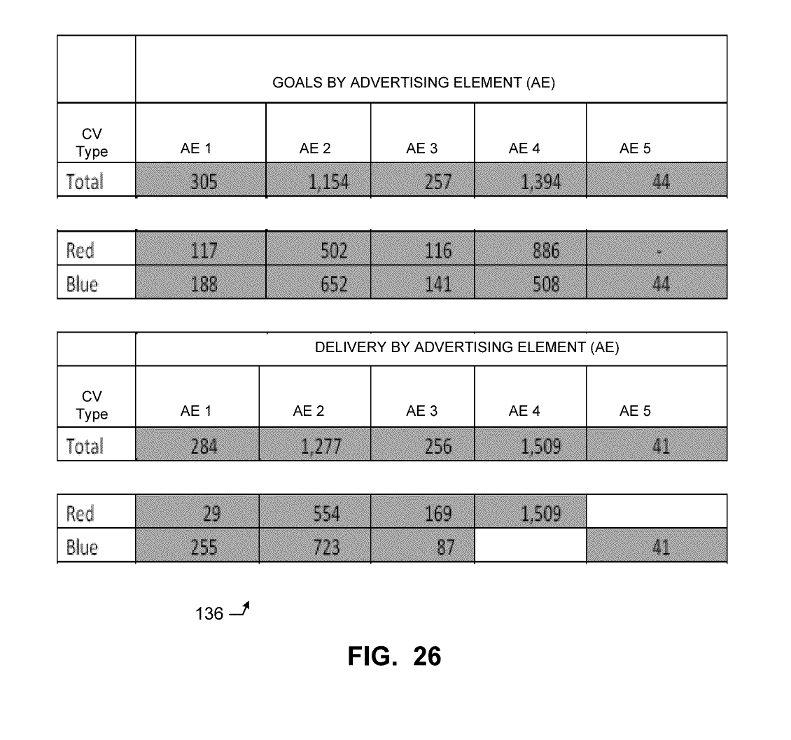

The example allocation system 100 of FIG. 1 includes a results table 136 to summarize results of the allocation process. An example of the results table 136 is illustrated in FIG. 26.

While an example manner of implementing the allocation system 100 is illustrated in FIG. 1, one or more of the elements, processes and/or devices illustrated in FIG. 1 may be combined, divided, re-arranged, omitted, eliminated and/or implemented in any other way. Further, the example advertising element obtainer 102, the example campaign variable obtainer 104, the example campaign variable type assignor 106, the example campaign variable efficacy obtainer 108, the example goal obtainer 110, the example campaign variable goal value obtainer 112, the example allocator 122, the example on-allocation penalty calculator 124, the example sorter 128, the example advertising element populator 130, the example goal manager 134, and/or, more generally, the example allocation system 100 of FIG. 1 may be implemented by hardware, software, firmware and/or any combination of hardware, software and/or firmware. Thus, for example, any of the example advertising element obtainer 102, the example campaign variable obtainer 104, the example campaign variable type assignor 106, the example campaign variable efficacy obtainer 108, the example goal obtainer 110, the example campaign variable goal value obtainer 112, the example allocator 122, the example on-allocation penalty calculator 124, the example sorter 128, the example advertising element populator 130, the example goal manager 134, and/or, more generally, the example allocation system 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this application to cover a purely software and/or firmware implementation, at least one of the example advertising element obtainer 102, the example campaign variable obtainer 104, the example campaign variable type assignor 106, the example campaign variable efficacy obtainer 108, the example goal obtainer 110, the example campaign variable goal value obtainer 112, the example allocator 122, the example on-allocation penalty calculator 124, the example sorter 128, the example advertising element populator 130, the example goal manager 134, and/or, more generally, the example allocation system 100 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example allocation system 100 of FIG. 1 may include one or more elements, processes and/or devices in addition to, or instead of, those illustrated in FIG. 1, and/or may include more than one of any or all of the illustrated elements, processes and devices.

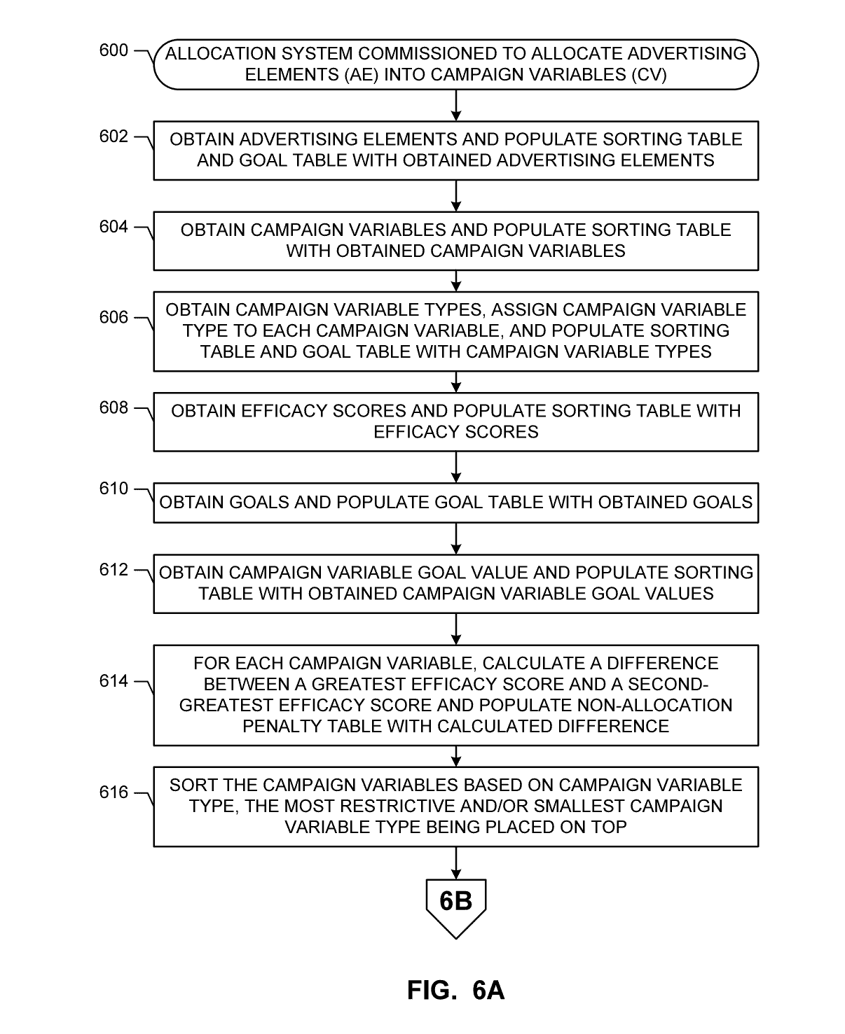

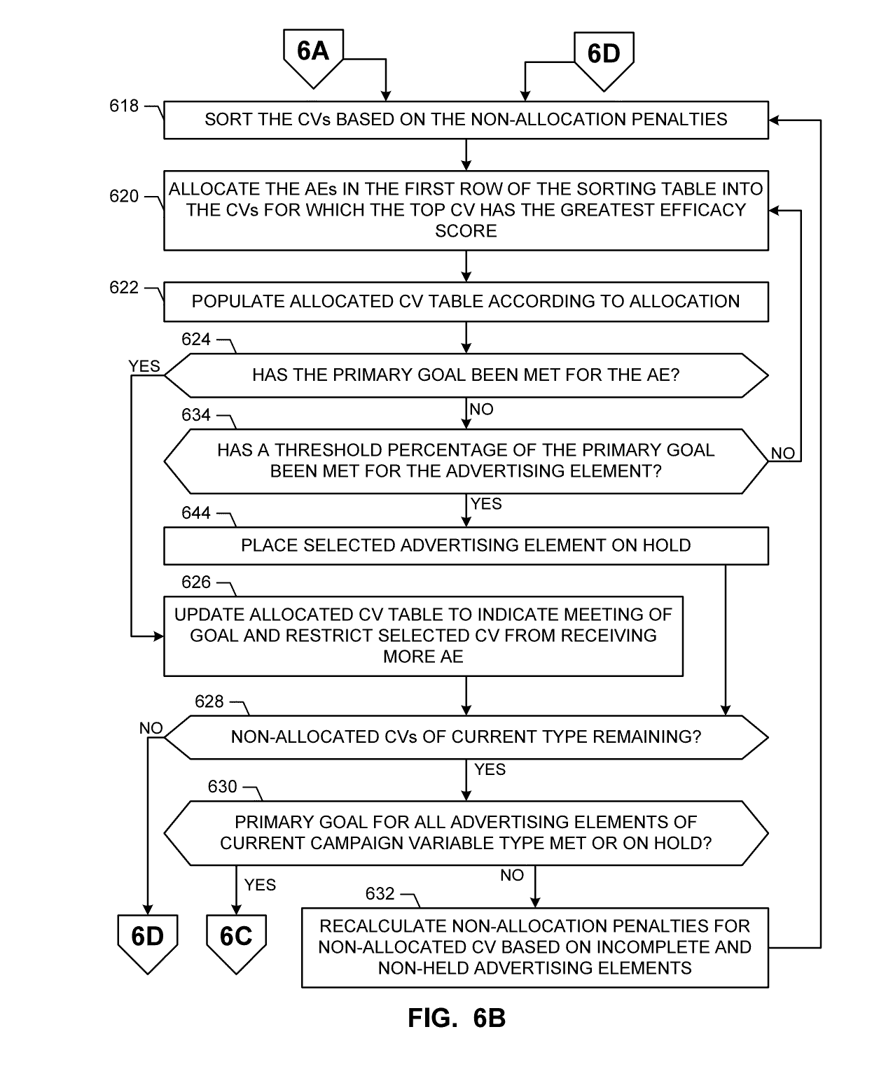

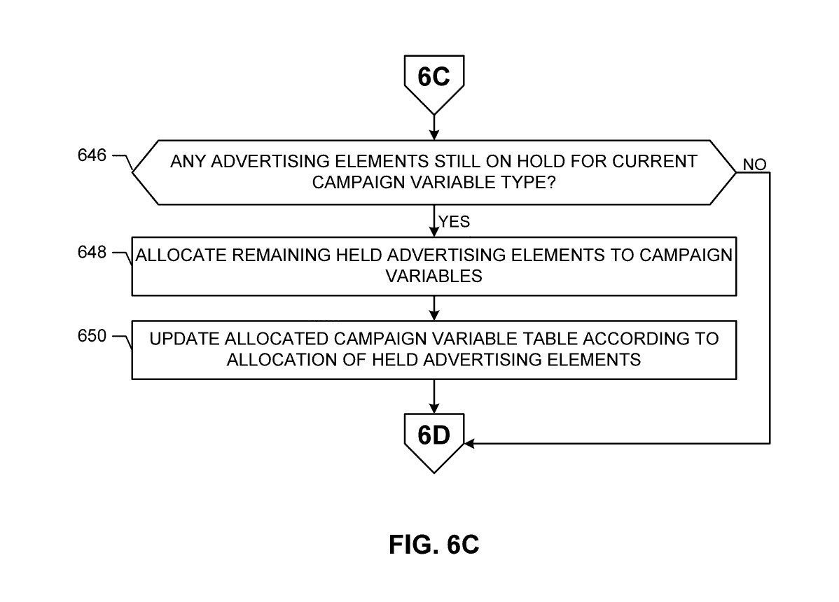

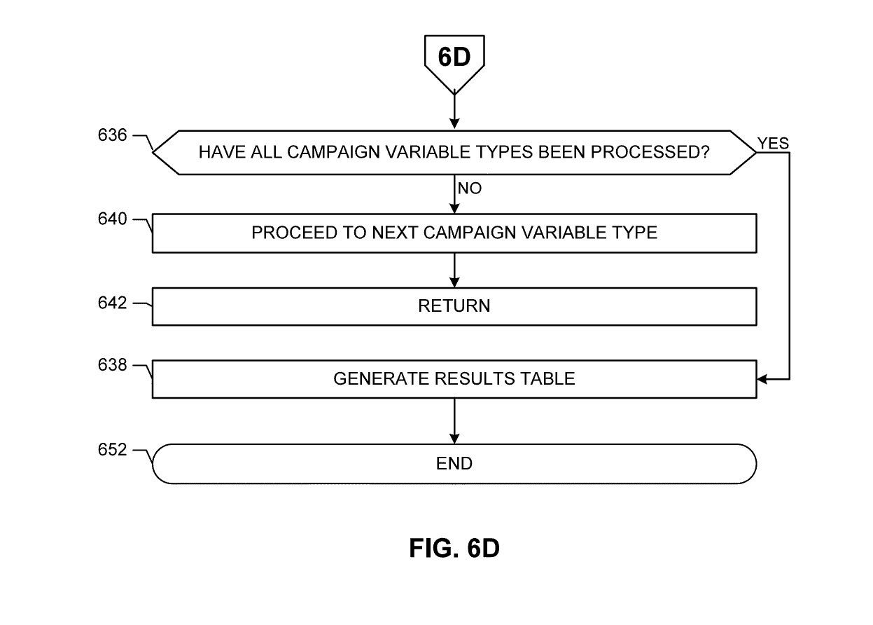

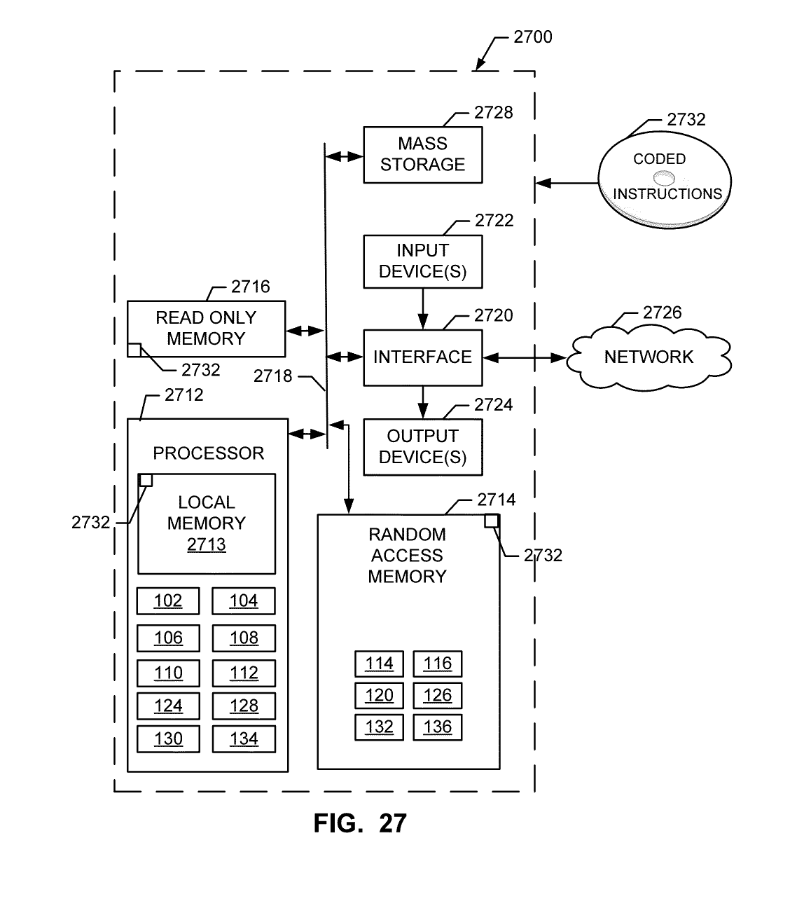

A flowchart representative of example machine readable instructions for implementing the example allocation system 100 of FIG. 1 is shown in FIGS. 6A-6D. In this example, the machine readable instructions comprise programs for execution by a processor such as the processor 2712 shown in the example computing platform 2700 discussed below in connection with FIG. 27. The programs may be embodied in software stored on a tangible computer readable storage medium such as a CD-ROM, a floppy disk, a hard drive, a digital versatile disk (DVD), a Blu-ray disk, or a memory associated with the processor 2712, but the entire programs and/or parts thereof could alternatively be executed by a device other than the processor 2712 and/or embodied in firmware or dedicated hardware. Further, although the example programs are described with reference to the flowcharts illustrated in FIGS. 6A-6D, many other methods of implementing the example allocation system 100 may alternatively be used. For example, the order of execution of the blocks may be changed, and/or some of the blocks described may be changed, eliminated, or combined.

As mentioned above, the example processes of FIGS. 6A-6D may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably.

Additionally or alternatively, the example processes of FIGS. 6A-6D may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

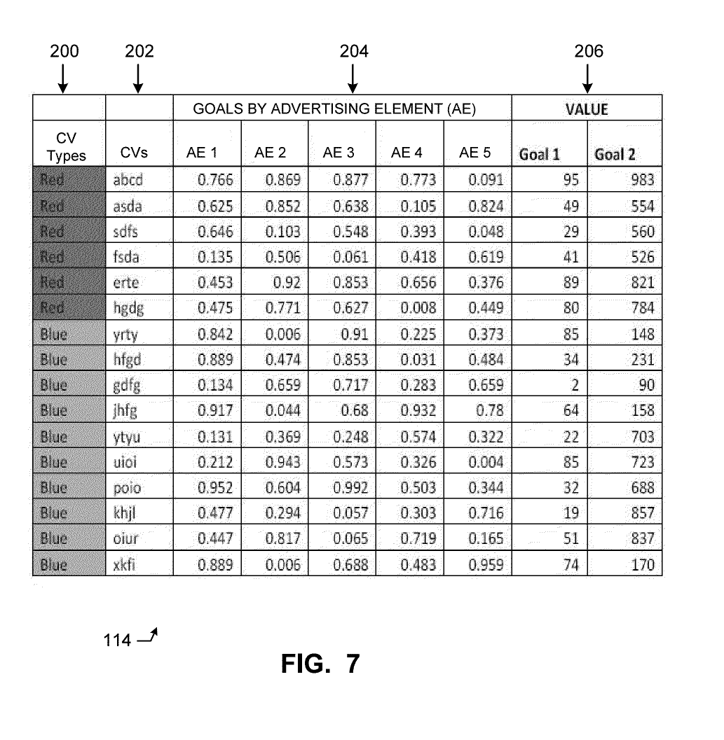

While the flowchart of FIGS. 6A-6D is described below in connection with example tables of FIGS. 7-26, additional or alternative values, campaign variable types, goals, number(s) of goals, hierarch of goals, sorting orders, etc. are possible.

FIG. 6A begins with the example allocation system 100 of FIG. 1 being tasked or commissioned with allocating a plurality of advertising elements associated with an advertising campaign into a plurality of campaign variables associated with the advertising campaign to achieve one or more goals of the advertising campaign (block 600). For example, the advertising campaign commissions the allocation system 100 to allocate brands (e.g., advertising elements) to advertisement slots (e.g., campaign variables) to achieve desired GRPs (e.g., a first goal) and/or desired expenditures (e.g., a second goal). To begin the allocation process, the example allocation system 100 collects information associated with the advertising campaign and populates data structures used in the allocation process with the obtained information.

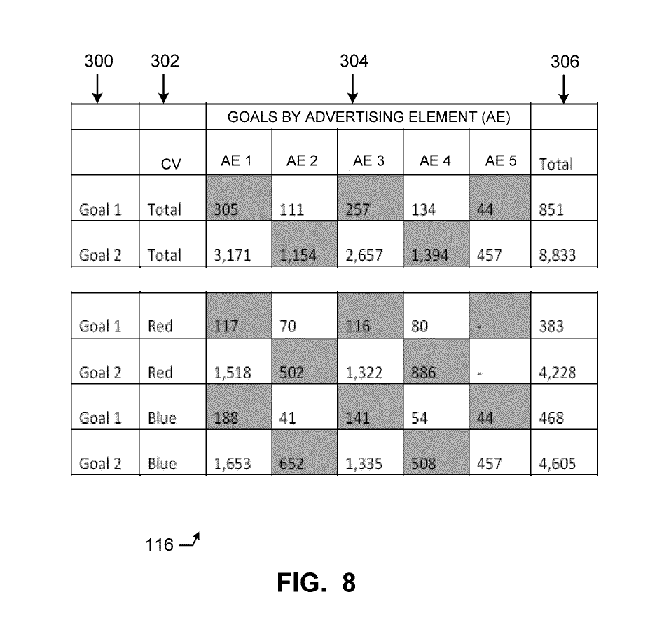

In the example of FIG. 6A, the advertising element obtainer 102 obtains the advertising elements associated with the advertising campaign and populates the sorting table 114 and the goal table 116 with the obtained advertising element information (block 602). For example, the third section 204 of the example sorting table of FIG. 2 is populated with identifiers representative of the different advertising elements (as shown in FIG. 7). Further, the third section 304 of the example goal table 116 of FIG. 3 is populated with those identifiers representative of the different advertising elements. In the example of FIG. 6A, five (5) advertising element are obtained and the sorting table 114 and the goal table 116 each includes five (5) corresponding advertising element identifiers (as shown in FIGS. 7 and 8). In the illustrated example, the advertising element represent brands of the advertising campaign.

In the example of FIG. 6A, the campaign variable obtainer 104 obtains the campaign variables associated with the advertising campaign and populates the sorting table 114 with the obtained campaign variable information (block 604). For example, the second section 202 of the example sorting table of FIG. 2 is populated with identifiers representative of the different campaign variables. In the example of FIG. 7, sixteen (16) campaign variables are obtained and the sorting table 114 includes sixteen (16) corresponding campaign variable identifiers. In the illustrated example, the campaign variables represent time slots associated with the advertising campaign.

In the example of FIG. 6A, the campaign variable type assignor 106 obtains the different type(s) associated with the adverting campaign, categorizes the campaign variables according to criteria of the campaign variable types, and populates the sorting table 114 and the goal table 116 accordingly (block 606). For example, the first section 200 of the example sorting table of FIG. 2 is populated with campaign variable type identifiers representative of the assigned campaign variable type. Further, the second section 302 of the example goal table 116 of FIG. 3 is populated with the campaign variable type identifiers. In the example of FIG. 6A, each campaign variable is one of two (2) campaign variable types, which are defined by a period of time at which the campaign variable occurs, a week during which the campaign variable occurs, and a duration of the item. In the illustrated example, the campaign variable types represent types of advertisement slots.

In the example of FIG. 6A, the campaign variable efficacy obtainer 108 obtains efficacy scores of the different advertising elements when assigned to a campaign variable and populates the sorting table 114 with the efficacy scores (block 608). For example, the third section 204 of the example sorting table 114 of FIG. 2 is populated with efficacy scores representative of the effectiveness of the respective advertising elements when assigned to the respective campaign variables (as shown in FIG. 7). In the illustrated example, the efficacy scores represent a likelihood that a person interested in the corresponding brand (e.g., advertising element) will consume media presented in the corresponding advertisement slot (e.g., campaign variable).

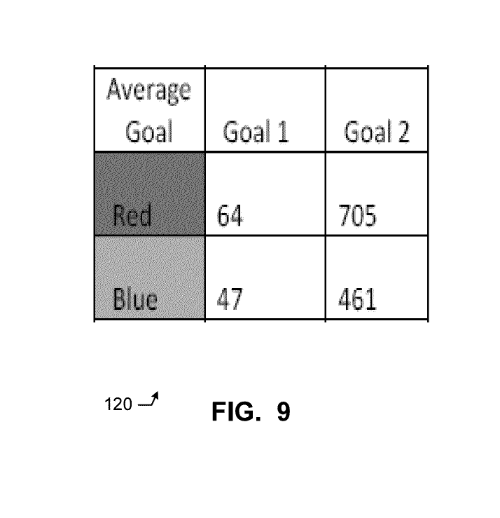

In the example of FIG. 6A, the goal obtainer 110 obtains one or more goals associated with the advertising campaign and populates the goal table 116 with the obtained goals (block 610). For example, the third section 304 of the example goal table 116 of FIG. 3 is populated with first and second goals for each campaign variable and for each campaign variable type (as shown in FIG. 8). In the illustrated example, the first goal is representative of a desired GPR and the second goal is representative of a desired cost. Further, the example fourth section 306 of the example goal table 116 is populated with totals of the goals. Further, in some examples, the average goal table 120 of FIG. 4 is populated with averages of the goals (as shown in FIG. 9).

In the example of FIG. 6A, the campaign variable goal value obtainer 112 obtains the campaign variable goal values of the campaign variables and populates the sorting table 114 with the obtained campaign variable goal values (block 612).

FIG. 7 illustrates an example state of the sorting table 114 after block 612 of FIG. 6A. As shown in FIG. 7, the sorting table 114 includes campaign variables of a first type designated with a ‘RED’ type identifier and a second type designated with a ‘BLUE’ type identifier. In the illustrated example, the ‘RED’ campaign variables are advertisement slots occurring at a first time of day (e.g., primetime), during a first week (e.g., Mar. 2, 2015 through Mar. 8, 2015), and having a first duration (e.g., thirty (30) seconds), while the ‘BLUE’ campaign variables are advertisement slots occurring at a second, different time of day (e.g., daytime), during the same first week, and having a second, different duration (e.g., fifteen (15) seconds). Accordingly, the campaign variable designated as ‘abcd’ in the example sorting table 114 of FIG. 7 is an advertisement slot of the ‘RED’ type, has an efficacy score for ‘Advertising element 1’ of 0.766, an efficacy score for ‘Advertising element 2’ of 0.869, etc., and would contribute a value of ninety-five (95) to the first goal and a value of nine-hundred eighty-three (983) to the second goal when the advertising elements are assigned to the campaign variable abcd as shown.

FIG. 8 illustrates an example state of the goal table 116 after block 612 of FIG. 6A. As shown in FIG. 8, the goal table 116 includes first goals for campaign variables of the ‘RED’ type for each of the advertising elements and second goals for campaign variables of the ‘BLUE’ type for each of the advertising elements. In the example of FIG. 8, each advertising element has a primary goal that is a driving goal of the allocation for the example of FIGS. 6A-6D. The primary goal for each advertising element is highlighted. Thus, for ‘Advertising element 1,’ the primary goal is ‘GOAL 1’ and, for ‘Advertising element 2, the primary goal is ‘GOAL 2.’ The example of FIG. 6A-6D described below allocates the advertising element in accordance with the primary goal. However, the allocation process disclosed herein can be driven by multiple goals (e.g., the primary and a secondary goal). For example, there may be a hierarchy between the goals such that a first goal is satisfied first, and a second, lower tiered goal is subsequently satisfied.

FIG. 9 illustrates an example state of the average goal table 120 after block 612 of FIG. 6A.

In the example of FIG. 6A, for each campaign variable in the sorting table 114, the non-allocation penalty calculator 124 calculates a different between a greatest one of the efficacy scores for that campaign variable and a second-greatest one of the efficacy scores for that campaign variable and populates the non-allocation penalty table 126 with the calculated differences (block 614). For example, when analyzing the campaign variable of the example sorting table 114 of FIG. 7 designated as ‘abcd,’ the non-allocation penalty calculator 124 identifies the efficacy score corresponding to ‘Advertising element 3’ (0.877) as the greatest efficacy score for campaign variable ‘abcd.’ Further, the non-allocation penalty calculator 124 identifies the efficacy score corresponding to ‘advertising element 2’ (0.869) as the second-greatest efficacy score for campaign variable ‘abcd.’ Further, the non-allocation penalty calculator 124 calculates the difference between these efficacy scores as 0.008. Accordingly, the non-allocation penalty calculated for campaign variable ‘abcd’ is 0.008. The example non-allocation penalty calculator 124 performs similar calculations for each campaign variables of the sorting table 114.

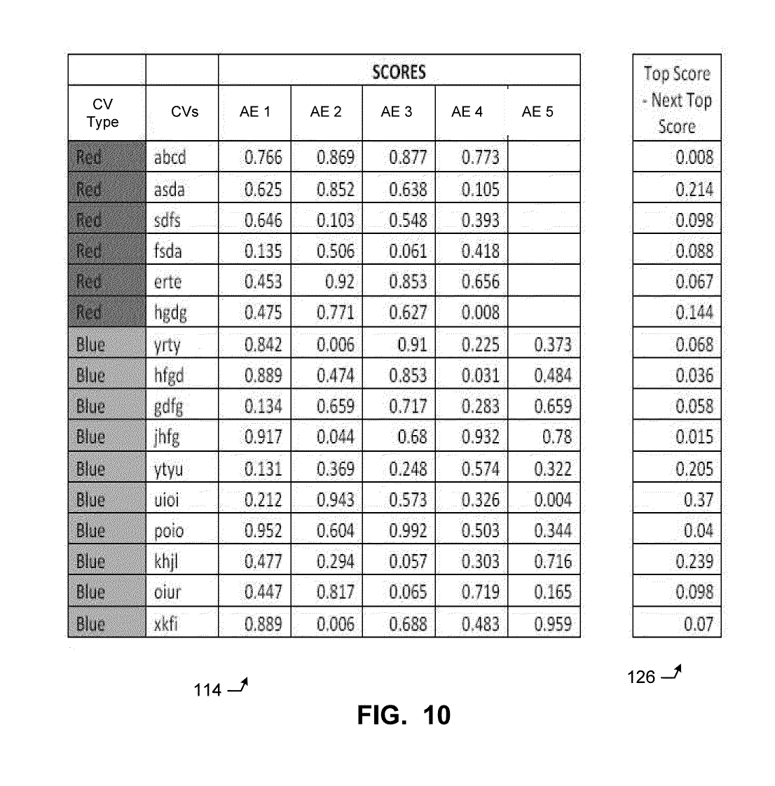

FIG. 10 illustrates an example state of the example non-allocation penalty table 126, adjacent the example sorting table 114 (the fourth section 306 of the sorting table 114 being omitted for purposes of illustration purposes), after block 614 of FIG. 6A. Note, in the example of FIG. 10, ‘Advertising element 5’ does not include efficacy scores because, according to the example goal table 116 of FIG. 8, campaign variables of the ‘RED’ type have a goals of zero (0).

In the example of FIG. 6A, the sorter 128 sorts the sorting table according to campaign variable type (block 616). In the illustrated example, the sorter 128 sorts the sorting table 114 such that campaign variables of the ‘RED’ type are placed above the campaign variables of the ‘BLUE’ type due to the ‘RED’ campaign variables being more restrictive and/or lesser in number than the ‘BLUE’ campaign variables. The example sorting table 114 of FIG. 10 includes the ‘RED’ campaign variables being sorted to the top of the sorting table 114. Control proceeds to FIG. 6B.

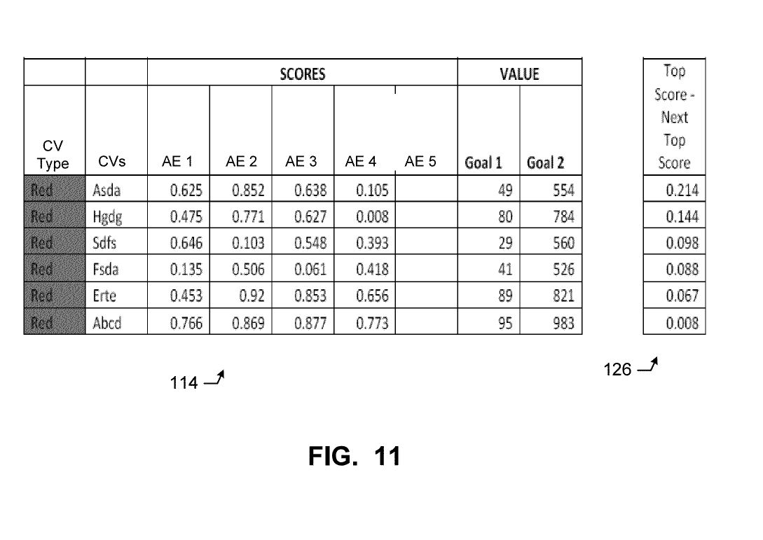

In the example of FIG. 6B, the sorter 128 sorts the campaign variables of the sorting table 116 according to the non-allocation penalties of the non-allocation penalty table 126 (block 618). FIG. 11 illustrates a portion of the sorting table 116 after block 618. In particular, the campaign variables have been sorted such that the campaign variable having the greatest non-allocation penalty (campaign variable ‘Asda’) is at placed at a first row of the sorting table 114.

In the example of FIG. 6B, the advertising element populator 130 allocates the advertising element in the first or top row having the greatest efficacy score to the campaign variable at the first or top row of the sorting table 114 (block 620). In the example of FIG. 11, the advertising element populator 130 determines that ‘Advertising element 2’ has a greatest efficacy score for the campaign variable ‘Asda’, the campaign variable in the top row of the sorting table 114. Accordingly, the advertising element populator 130 allocates ‘Advertising element 2’ to campaign variable ‘Asda.’

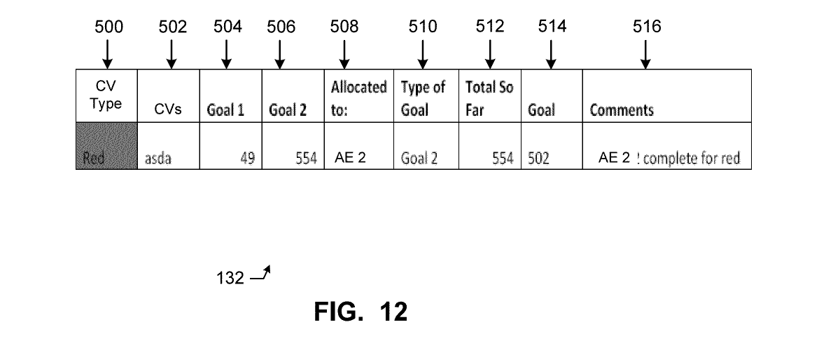

In the example of FIG. 6B, the advertising element populator 130 populates the allocated campaign variable table 132 with information associated with the allocation of the advertising element of the top row into the selected campaign variable (block 622). FIG. 12 illustrates an example state of the allocated campaign variable table 132 after a first instance of this population. As indicated in FIG. 12, the campaign variable designated ‘Asda’ (as shown in the second section 502) is of the ‘RED’ type (as shown in the first section 500), has a goal value for ‘GOAL 1’ of forty-nine (49) (as shown in the third section 504), has a goal value for ‘GOAL 2’ of five-hundred fifty-four (554) (as shown in the fourth section 506), and ‘Advertising element 2’ was assigned to the campaign variable designated ‘Asda’ (as shown in the fifth section 508). Further, the example advertising element populator 130 utilizes the example goal table 116 of FIG. 8 to determine that the primary goal for ‘RED campaign variables in ‘Advertising element 2’ is ‘GOAL 2.’ Thus, the advertising element populator 130 enters ‘GOAL 2’ into the sixth section 510 of the example allocated campaign variable table 132 of FIG. 12. Moreover, because the primary goal is ‘GOAL 2,’ the advertising element populator 130 indicates in the allocated campaign variable table 132 (in the seventh section 512) that campaign variable ‘Asda’ contributed a value of five-hundred fifty-four (554) (from the fourth section 506) to ‘GOAL 2.’ Because the example state of the allocated campaign variable table 132 corresponds to a first allocation of an advertising element, the ‘total so far’ of the seventh section 512 is the goal value of the one allocated advertising element. However, as additional advertising element are allocated to campaign variables, the goal values are added to that total.

In the example of FIG. 6B, the goal manager 134 determines whether the primary goal of the advertising element assigned to the campaign variable has been met (block 624). For example, the goal manager 134 analyzes the seventh section 512 and the eighth section 514 of the allocated campaign variable table 132. In the example state of the allocated campaign variable table 132 of FIG. 12, the primary goal of ‘Advertising element 2’ has been met and, thus, the goal manager 134 updates the allocated campaign variable table 132 (e.g., in the ninth section 516) to indicate that the primary goal for ‘Advertising element 2’ has been met (block 626). Additionally, in the example of FIG. 6B, the goal manager 134 restricts the satisfied advertising element (‘Advertising element 2’ in the example of FIG. 12) from being assigned to more campaign variables (block 626). In the illustrated example, this restriction includes removing the efficacy scores of the sorting table 114 corresponding to the satisfied advertising element within the campaign variable type of the allocated campaign variable. Thus, in the illustrated example, the goal manager 134 restricts ‘Advertising element 2’ from being assigned to more ‘RED’ type campaign variables.

In the example of FIG. 6B, the example allocator 122 determines whether campaign variables of the current campaign variable type (e.g., the ‘RED’ type campaign variables) remain in the sorting table 114 (block 628). That is, the allocator 122 determines whether any of the campaign variables of the type currently having advertising element assigned, have not yet been assigned an advertising element. If no such campaign variables remain in the sorting table 114 (e.g., all campaign variables of the current campaign variable type have been assigned an advertising element (block 628), control proceeds to FIG. 6D, which is described below. If campaign variables without assigned advertising elements of the current type remain (block 628), the example goal manager 134 determines whether all advertising element of the current campaign variable type have been satisfied (e.g., the corresponding primary goal has been fully achieved) or placed on hold (block 630). Advertising element placed on hold are described below in connection with block 634. If the goal manager 134 determines that the primary goal for at least one of the advertising element has not been met or that at least one of the advertising element is not on hold (block 630), the non-allocation penalty calculator 124 recalculates the non-allocation penalty for each remaining campaign variable of the sorting table 114 (block 632). The results of the recalculation are likely to differ from their previous values due to one or more advertising element having been satisfied or placed on hold and, thus, removed from the non-allocation penalty calculations.

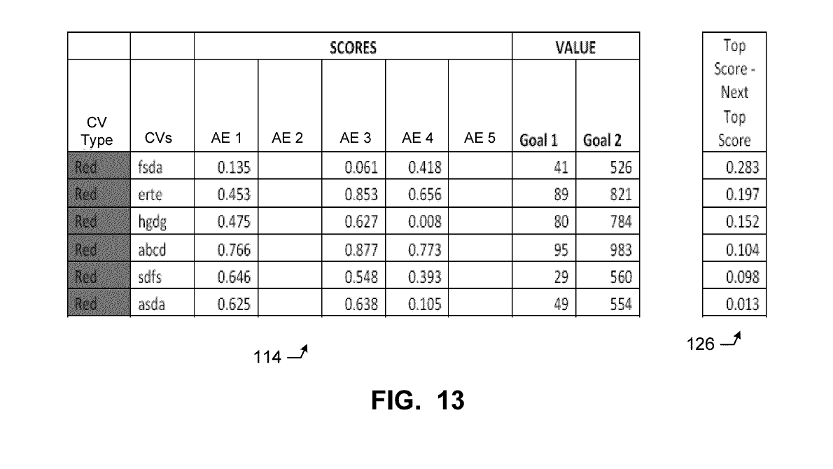

FIG. 13 illustrates an example state of the non-allocation penalty table 126 after block 632. As shown in FIG. 13, certain ones of the non-allocation penalties are different from those of FIG. 11 due to ‘Advertising element 2’ having been completed.

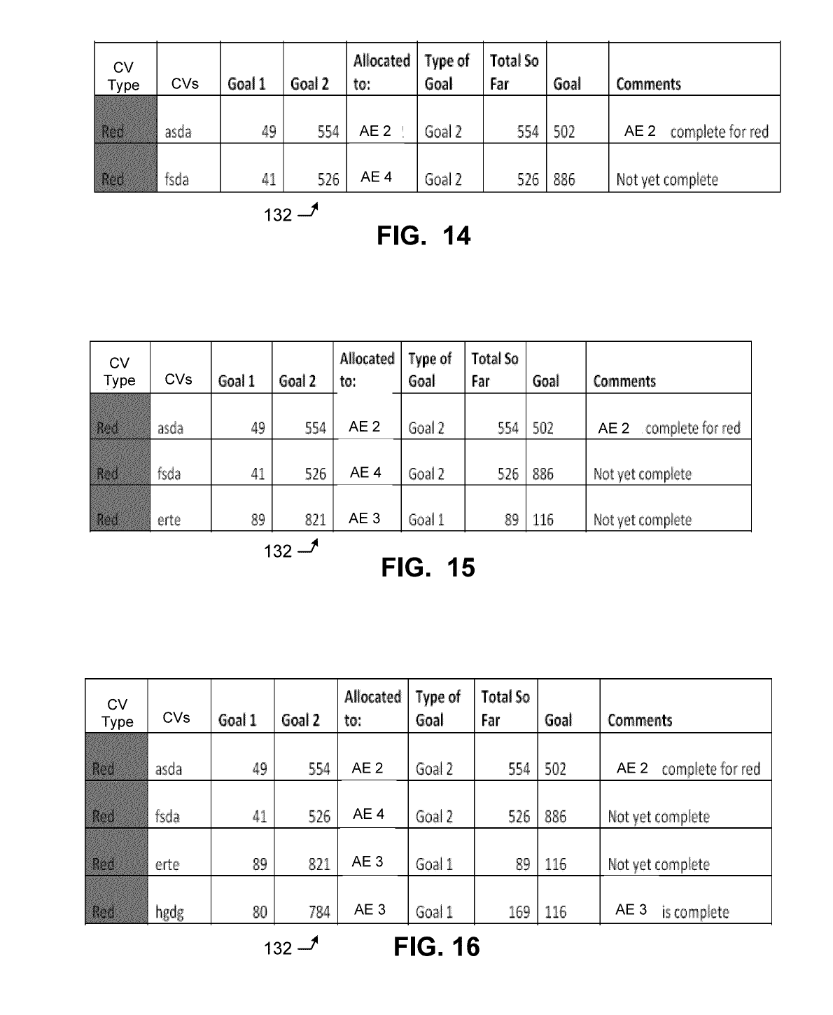

In the example of FIG. 6B, control proceeds to block 618 from block 632 and the sorting table 114 is resorted based on the new non-allocation penalties. FIG. 13 illustrates a state of the sorting table 114 after this iteration of block 618. As shown in FIG. 13, the campaign variables of the sorting table 114 are in a different order. As such, at this iteration of block 620, the advertising element populator 130 allocates ‘Advertising element 4’ to campaign variable ‘fsda.’ Further, at this iteration of block 622, the advertising element populator 130 updates the allocated campaign variable table 132 to indicate the information associated with ‘Advertising element 4’ assigned to campaign variable ‘fsda.’ FIG. 14 illustrates an example state of the allocated campaign variable table 132 after this iteration of block 622.

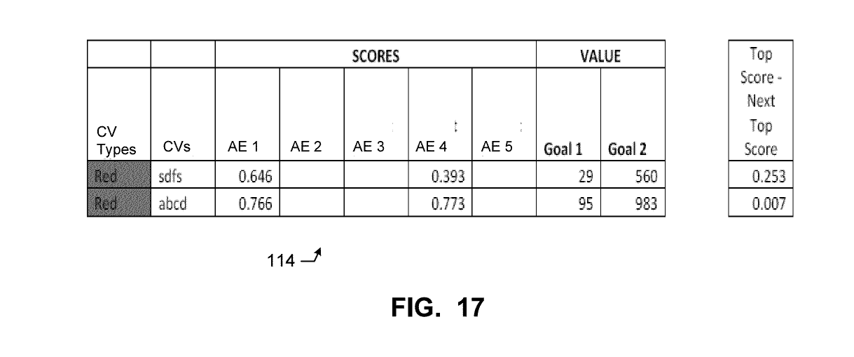

The example of FIG. 6B continues in this fashion. FIGS. 14-16 illustrate example states of the allocated campaign variable table 132 as the advertising element are allocated to the campaign variables according to the sorting table 114. FIG. 17 illustrates an example state of the sorting table 114 after ‘Advertising element 3’ is completed, as indicated in FIG. 16.

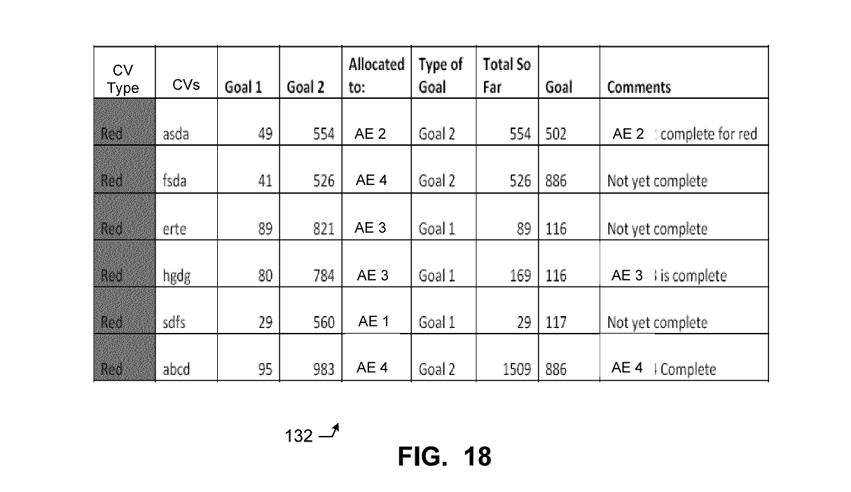

In the example scenario represented by the example FIGS. 14-17, all of the campaign variables of the ‘RED’ campaign variable type have been assigned an advertising element. The corresponding state of the allocated campaign variable table 132 is illustrated in FIG. 18. As such, in the example of FIG. 6B, when there are no unallocated campaign variables remaining (block 628), control proceeds to FIG. 6D. In the example of FIG. 6D, the allocator 122 determines whether all campaign variable types (e.g., ‘RED’ and ‘BLUE’) have been processed (block 636). If all campaign variables types have been processed (block 636), the example results table 136 is generated (block 638). Otherwise, the example allocator 122 proceeds to the next campaign variable type (e.g., ‘BLUE’) (block 640) and control returns to FIG. 6B (block 642).

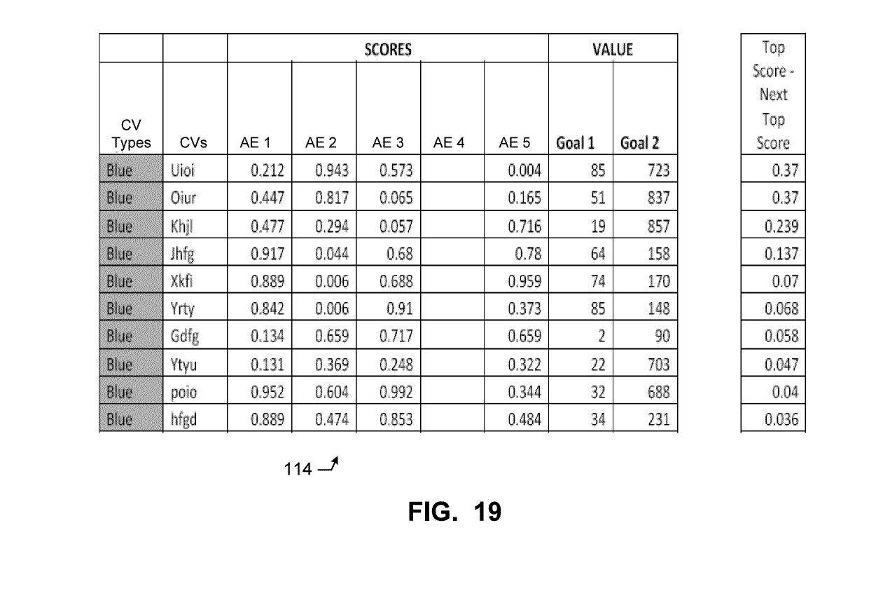

FIG. 19 illustrates an example state of a portion of the sorting table 114 corresponding to the ‘BLUE’ campaign variables. In the example of FIG. 6B, the allocator 122 processes the ‘BLUE’ campaign variables as described above in connection with the ‘RED’ campaign variables. Notably, the goals used for the second (and subsequent) campaign variable types, are the total goals listed in the example goal table 116. For example, the goal for ‘Advertising element 4’ while processing the ‘BLUE’ campaign variables is 1,394 (as shown in FIG. 8). In the example of FIG. 19, the primary goal for ‘Advertising element 4’ has already been met via the allocation of the ‘RED’ campaign variables to ‘Advertising element 4.’ Thus, the efficacy scores are not included in the sorting table 114 for ‘Advertising element 4’ and ‘Advertising element 4’ is restricted from being assigned to campaign variables. In the example of FIG. 19, ‘Advertising element 5’ is populated due to the goal table 116 of FIG. 8 includes goals for the ‘BLUE’ campaign variables.

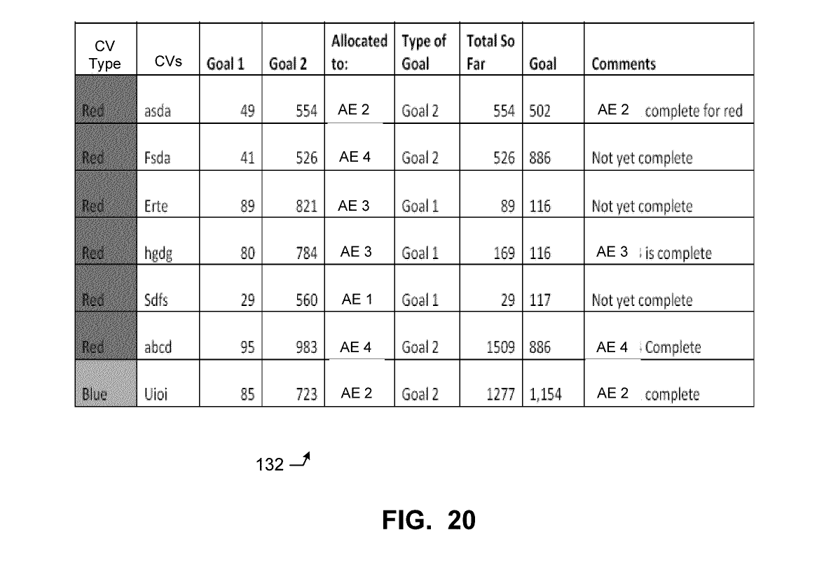

Per the sorting of the sorting table 114 according to the non-allocation penalties, as illustrated in FIG. 19, ‘Advertising element 2’ is assigned to campaign variable ‘Uioi’ (block 620). Further, the advertising element populator 130 updates the allocated campaign variable table 132 according to the assignment of ‘Advertising element 2’ to campaign variable ‘Uioi’ (block 622). FIG. 20 illustrates an example state of the allocated campaign variable table 132 after the allocation of ‘Advertising element 2’ to campaign variable ‘Uioi.’ In particular, the tracking of the contributions made to GOAL 2 of ‘Advertising element 2’ is the total of the contribution from campaign variable ‘Uioi’ and previous contributions from ‘RED’ campaign variables.

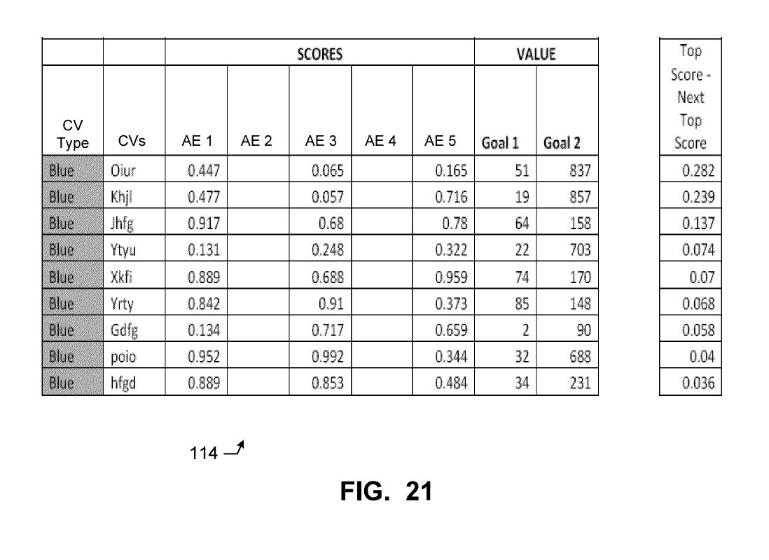

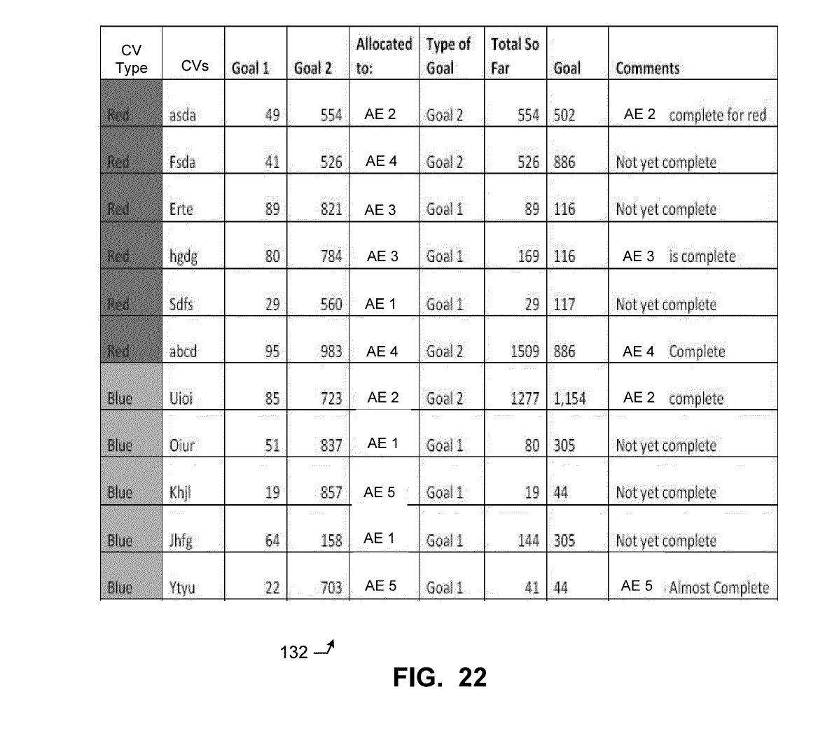

The example of FIG. 6B continues to process the ‘BLUE’ campaign variables. FIG. 21 illustrates an example state of the sorting table 114 as the ‘BLUE’ campaign variables are processed. FIG. 22 illustrates an example state of the allocated campaign variable table 132 after allocation of ‘advertising element 5’ to campaign variable ‘Ytyu,’ which corresponds to block 622 of FIG. 6B. In the illustrated example, the primary goal has not been met for ‘Advertising element 5’ as the total so far is 41 and the goal is 44 (block 624). However, the example goal manager 134 determines that a threshold percentage (e.g., ninety (90) percent) of the goal has been met for ‘Advertising element 5’ (block 634). Accordingly, the example goal manager 134 places ‘Advertising element 5’ on hold, thereby restricting ‘Advertising element 5’ from being assigned to additional campaign variables unit all Advertising element have been satisfied or placed on hold (block 644). In the example of FIG. 19, this is indicated as ‘Advertising element 5’ being described as ‘Almost Complete.’

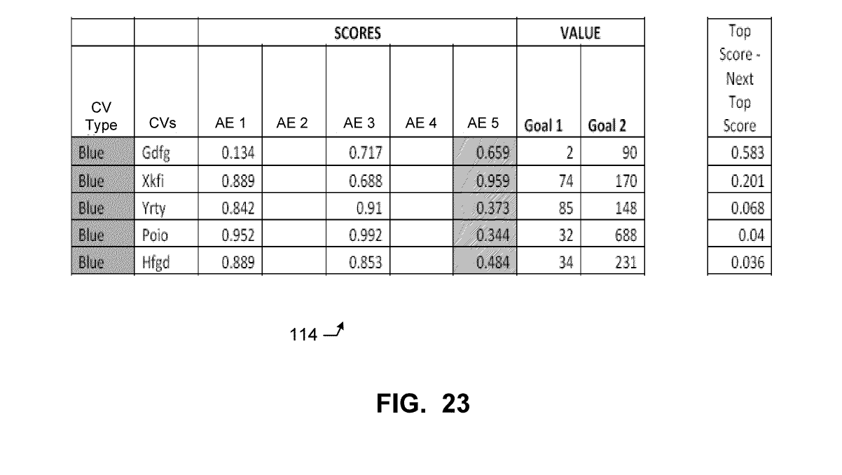

FIG. 23 illustrates an example state of the sorting table 114 with ‘Advertising element 5’ on hold. When the non-allocation penalty calculator 124 recalculates the non-allocation penalties, the efficacy scores of any buckets on hold are not considered (e.g., are ineligible for selection as the greatest or second-greatest efficacy score).

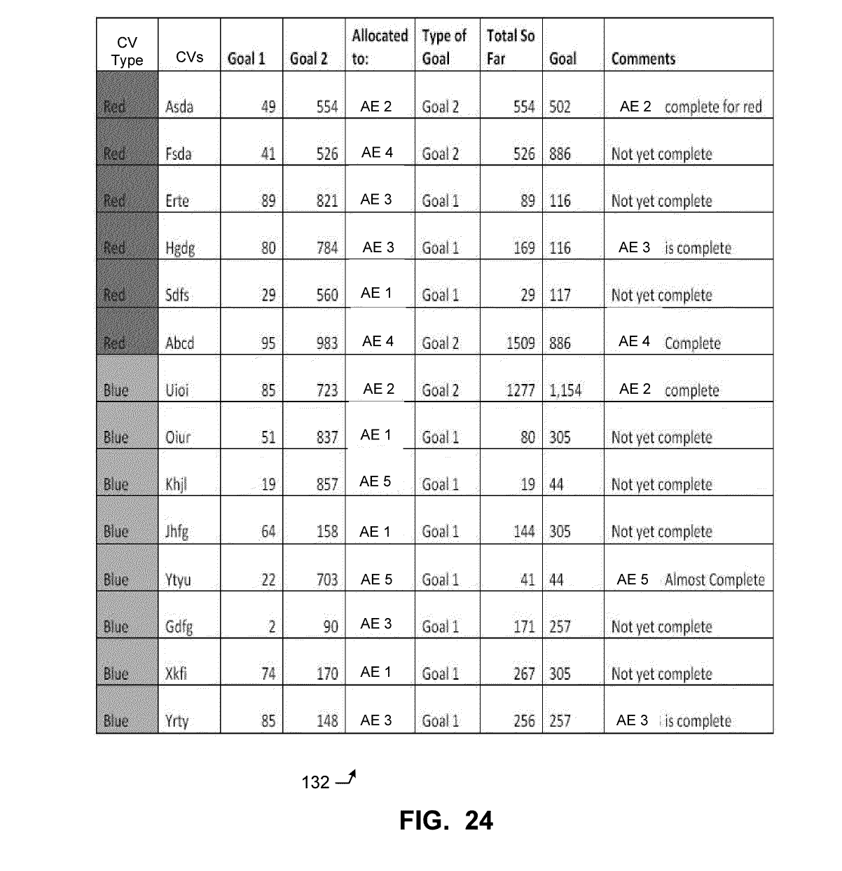

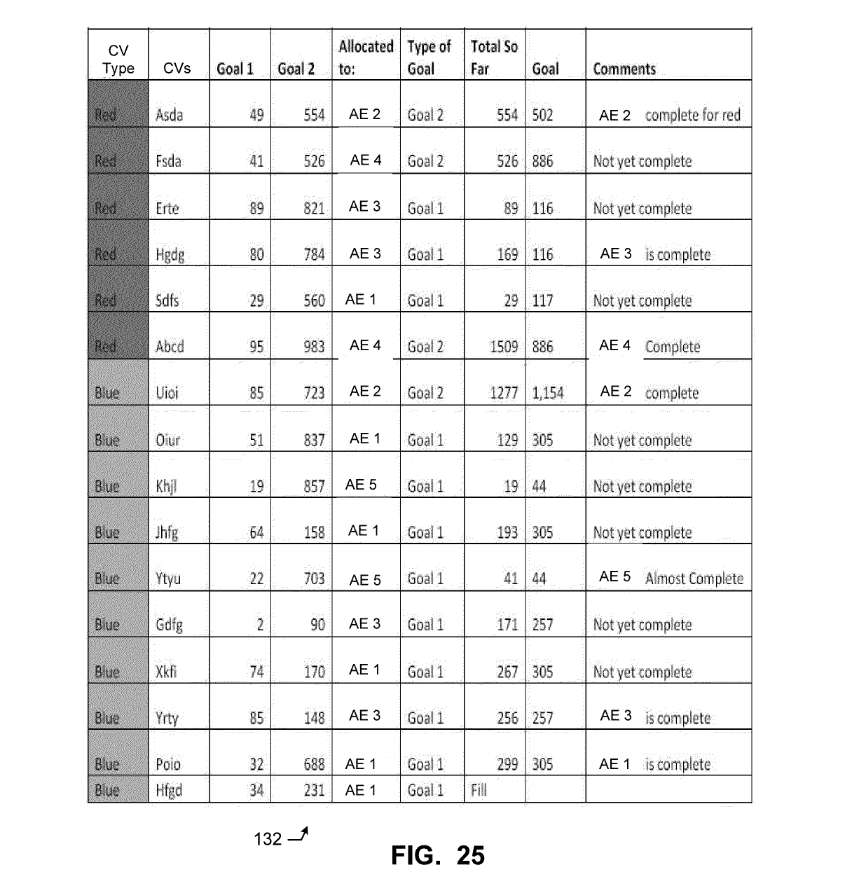

The allocation process of FIG. 6B continues. FIG. 24 illustrates an example state of the allocated campaign variable table 132 when ‘Advertising element 3’ is completed. FIG. 25 illustrates an example state of the allocated campaign variable table 132 when ‘Advertising element 1’ is completed. As such, all Advertising element are either completed or on hold. Accordingly, at block 630 of FIG. 6B, control proceeds to FIG. 6C. In the example of FIG. 6C, if any advertising element are on hold for the current campaign variable type (block 646), any remaining advertising element(s) are assigned to campaign variables (block 648). The example allocated campaign variable table is updated accordingly (block 650). Control proceeds to FIG. 6D.

As described above, in the example of FIG. 6D, if all campaign variables have had advertising element(s) assigned (block 636), the results table is generated (block 638). FIG. 26 illustrates an example state of the results table 136. The example of FIGS. 6A-6D ends (block 652).

FIG. 27 is a block diagram of an example computing platform 2700 to execute the instructions of FIGS. 6A-6D to implement the example allocation system 100 of FIG. 1. The computing platform 2700 can be, for example, a server, a personal computer, or any other type of computing device.

The computing platform 2700 of the illustrated example includes a processor 2712. The processor 2712 of the illustrated example is hardware. For example, the processor 2712 can be implemented by one or more integrated circuits, logic circuits, microprocessors or controllers from any desired family or manufacturer. In the illustrated example of FIG. 27, the bucket obtainer 102, the campaign variable obtainer 104, the campaign variable type assignor 106, the campaign variable efficacy obtainer 108, the goal obtainer 110, the campaign variable goal value obtainer 112, the allocator 122, the non-allocation penalty calculator 124, the sorter 128, the advertising element populator 130, and/or the goal manager 134 is/are implemented via the example processor 2712.

The processor 2712 of the illustrated example includes a local memory 2713 (e.g., a cache). The processor 2712 of the illustrated example is in communication with a main memory including a volatile memory 2714 and a non-volatile memory 2716 via a bus 2718. The volatile memory 2714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2716 may be implemented by flash memory and/or any other desired type of memory device. Access to the main memory 2714, 2716 is controlled by a memory controller. In the illustrated example of FIG. 27, the sorting table 114, the goal table 116, the average goal table 120, the non-allocation penalty table 126, the allocated campaign variable table 132, and/or the results table 136 is/are implemented in the random access memory 2714. In other examples, the tables may be located in local memory 2713 or mass storage 2728.

The computing platform 2700 of the illustrated example also includes an interface circuit 2720. The interface circuit 2720 may be implemented by any type of interface standard, such as an Ethernet interface, a universal serial bus (USB), and/or a PCI express interface.

In the illustrated example, one or more input devices 2722 are connected to the interface circuit 2720. The input device(s) 2722 permit(s) a user to enter data and commands into the processor 2712. The input device(s) can be implemented by, for example, an audio sensor, a microphone, a camera (still or video), a keyboard, a button, a mouse, a touch screen, a track-pad, a trackball, isopoint and/or a voice recognition system.

One or more output devices 2724 are also connected to the interface circuit 2720 of the illustrated example. The output devices 2724 can be implemented, for example, by display devices (e.g., a light emitting diode (LED), an organic light emitting diode (OLED), a liquid crystal display, a cathode ray tube display (CRT), a touch screen, a tactile output device, a printer and/or speakers). The interface circuit 2720 of the illustrated example, thus, typically includes a graphics driver card, a graphics driver chip or a graphics driver processor.

The interface circuit 2720 of the illustrated example also includes a communication device such as a transmitter, a receiver, a transceiver, a modem and/or network interface card to facilitate exchange of data with external machines (e.g., computing devices of any kind) via a network 2726 (e.g., an Ethernet connection, a digital subscriber line (DSL), a telephone line, coaxial cable, a cellular telephone system, etc.).

The computing platform 2700 of the illustrated example also includes one or more mass storage devices 2728 for storing software and/or data. In some examples, the example real-time database 404 of FIG. 4 is implemented via the example one more mass storage devices 2728 of FIG. 27. Examples of such mass storage devices 2728 include floppy disk drives, hard drive disks, compact disk drives, Blu-ray disk drives, RAID systems, and digital versatile disk (DVD) drives.

Coded instructions 2732 of FIGS. 6A-6D may be stored in the mass storage device 2728, in the volatile memory 2714, in the non-volatile memory 2716, and/or on a removable tangible computer readable storage medium such as a CD or DVD.

The examples described above allocate advertising elements having different efficacies/effectiveness for different purposes (e.g., driving sale, promoting brand recognition, etc.) to target groups or advertising campaign variables, based on criteria and/or goals of a program (e.g., an advertising campaign). The scope of coverage of this application is not limited to the examples described above. The scope of coverage of this application includes other applications of allocating elements to target groups. One additional example includes allocating households into different segments based on propensity scores (instead of buyergraphic scores) to meet goals for the number of households in each segment, such that each segment has the highest possible propensity scores. Another example includes allocating households into groups based on their demographic composition (instead of dayparts or CPMs) to create subsets of households to allocate in steps.

Although certain example methods, apparatus and articles of manufacture have been disclosed herein, the scope of coverage of this application is not limited thereto. On the contrary, this application covers all methods, apparatus and articles of manufacture fairly falling within the scope of the claims of this application.

1. A method, comprising:
selecting one of a first campaign variable and a second campaign variable based on a first penalty associated with the first campaign variable and a second penalty associated with the second campaign variable, the first penalty representative of non-allocation of a first one of advertising elements to the first campaign variable, the second penalty representative of non-allocation of a second one of advertising elements to the second campaign variable;
selecting a target advertising element based on efficacy scores associated with the selected one of the first and second campaign variables; and
allocating the target advertising element to the selected one of the first and second campaign variables.

2. A method as defined in claim 1, further including calculating the first penalty.

3. A method as defined in 2, wherein the calculating of the first penalty includes determining a difference between a first efficacy score of the first campaign variable for the first one of the advertising elements and a second efficacy score of the first campaign variable for a third one of the advertising elements.

4. A method as defined in claim 3, wherein the calculating of the first penalty includes:
selecting a greatest one of the efficacy scores of the first campaign variable as the first efficacy score; and
selecting a second-greatest one of the efficacy scores of the first campaign variable as the second efficacy score.

5. A method as defined in claim 3, wherein the efficacy scores represent respective likelihoods that a corresponding advertising element will be effective for the corresponding campaign variables.

6. A method as defined in claim 1, wherein the first one of the advertising elements and the second one of the advertising elements are a same advertising element.

7. (canceled)

8. A method as defined in claim 1, further including sorting a table based on the first and second penalties, wherein the selecting of the one of the first and second campaign variables is based on the table.

9. A method as defined in claim 1, further including assigning types to the first and second campaign variables.

10. A method as defined in claim 1, further including tracking a contribution amount to a goal associated with the target advertising element.

11. A method as defined in claim 1, further including determining if the allocating of the target advertising element to the selected one of the first and second campaign variables causes a goal associated with the target advertising element to be achieved.

12. A method as defined in claim 11, further including, when the allocating of the target advertising element to the selected one of the first and second campaign variables causes the goal associated with the target advertising element to be achieved, restricting subsequent allocation of the target advertising element to campaign variables.

13. A method as defined in claim 12, further including, in response to the restricting of the subsequent allocation of the target advertising element to the campaign variables, recalculating the penalties for unallocated campaign variables.

14. A method as defined in claim 1, further including determining whether the allocating of the target advertising element to the selected one of the first and second campaign variables caused a threshold percentage of a goal associated with the target advertising element to be met.

15. A method as defined in claim 14, further including, in response to determining that the threshold percentage of the goal is met, placing the target advertising element on hold.

16. A method as defined in claim 14, wherein the campaign variables are advertisement slots.

17. A method as defined in claim 14, wherein the advertising elements are one of a brand, a product, a product category, a service, a service category or a marketplace.

18. A tangible computer readable medium comprising instructions that, when executed, cause a machine to at least:
select one of a first campaign variable and a second campaign variable based on a first penalty associated with the first campaign variable and a second penalty associated with the second campaign variable, the first penalty representative of non-allocation of a first one of advertising elements to the first campaign variable, the second penalty representative of non-allocation of a second one of advertising elements to the second campaign variable;
select a target advertising element based on efficacy scores associated with the selected one of the first and second campaign variables; and
allocate the target advertising element to the selected one of the first and second campaign variables.

19. (canceled)

20. (canceled)

21. (canceled)

22. (canceled)

23. (canceled)

24. (canceled)

25. A computer readable medium as defined in claim 18, wherein the instructions, when executed, cause the machine to sort a table based on the first and second penalties, wherein the instructions cause the machine to, when executed, select the one of the first and second campaign variables based on the table.

26. (canceled)

27. (canceled)

28. (canceled)

29. (canceled)

30. (canceled)

31. (canceled)

32. (canceled)

33. (canceled)

34. (canceled)

35. An apparatus, comprising:
a penalty calculator to calculate a first penalty representative of non-allocation of a first one of advertising elements to the first campaign variable, and a second penalty representative of non-allocation of a first one of advertising elements to the first campaign variable; and
a populator to:
select one of the first and second campaign variables based on the first and second penalties;
select a target advertising element based on efficacy scores associated with the selected one of the first and second campaign variables; and
allocate the target advertising element to the selected one of the first and second campaign variables.

36. An apparatus as defined in claim 35, wherein the penalty calculator is to calculate the first penalty by determining a difference between a first efficacy score of the first campaign variable for the first one of the advertising elements and a second efficacy score of the first campaign variable for a third one of the advertising elements.

37.-50. (canceled)
